(19) United States
(12) Patent Application Publication
(10) Pub. No.: US 2003/0179896 A1
(43) Pub. Date: Sep. 25, 2003

(54) Hearing instrument adjustment system

(76) Inventor: Todd Michael Putvinski, Allentown, NJ (US)

Correspondence Address: Alexander J. Burke, SIEMENS CORPORATION, 170 WOOD AVENUE SOUTH, ISELIN, NJ, 08830, US

(21) Appl. No.: 10/345,867

(22) Filed: Jan. 16, 2003

Related U.S. Application Data
(60) Provisional application No. 60/365,414, filed on Mar. 19, 2002.

(51) Int. Cl. H04R 25/00

(52) U.S. Cl. 381/323; 381/312; 381/314

(57) ABSTRACT

A hearing instrument and external fitting device for adjusting, or “trimming”, the circuit characteristics of a hearing instrument. The external fitting device includes a set of external trimmer elements which are connected into the hearing instrument internal circuitry, where the values of the trimmer elements are periodically sampled by the instrument's circuitry when the fitting device is connected to the instrument, the values of the trimmer elements being stored in an internal memory to control the characteristics of the hearing instrument. When a satisfactory set of adjustment values are achieved, the fitting device is disconnected from the hearing instrument until required for further adjustments. A fitting card is associated with each instrument and identifies the instrument or user of the instrument and may be fitted to the fitting device to record the settings of the trimmer elements.

### CROSS REFERENCES TO RELATED APPLICATIONS

This patent application is related to and claims benefit of priority from U.S. Provisional Patent Application Serial No. 60/365,515 filed Mar. 19, 2002 by Todd Michael Putvinski for A HEARING INSTRUMENT ADJUSTMENT MODULE.

### FIELD OF THE INVENTION

The present invention relates to hearing instruments and, in particular, to a method and apparatus for externally adjusting the settings, or fitting, of a hearing instrument.

### BACKGROUND OF THE INVENTION

A hearing instrument is an electronic amplifier device generally designed to fit within the user's ear or ear canal and to assist the user's hearing by appropriate amplification and modification of sounds reaching a microphone in the hearing instrument. Such devices are electrically powered, usually by batteries, and may contain very complex acoustic processing and amplification circuitry. The devices are typically manufactured with a limited number of sets of circuitry, each circuitry set being adapted to the general and specific needs of a group of users having at least some common characteristics and a particular set being selected for a given user depending upon the user's needs. An instrument having the circuitry set most appropriate to a given user is then adjusted, or “fitted”, to an specific user by appropriate adjustment of the circuitry.

The characteristics of a hearing device are most frequently “fitted” to a given user by means of “trimmers” in the circuitry, such as variable resistors. The most common method has been by means of trimmers physically located within the hearing instrument and accessible to a suitable adjustment tool, such as a screwdriver, through a hatch or openings in the shell of the instrument.

Although this method is relatively simple, trimmers of a size and design to fit within a hearing instrument are costly and the number of trimmers that can be fitted into a given instrument are limited by the available space within the instrument shell. The use of internal trimmers thereby increases the cost and complexity of the instrument, and of the manufacture and assembly of the instrument. Also, the provision of a hatch or openings through which the trimmers may be adjusted weakens the instrument shell and may allow dirt and moisture to get into the instrument and the circuitry therein.

Another known method for fitting hearing instrument circuitry is “programming” of the circuitry by an external system, such as a program controlled computer or equivalent device, which is connected to the instrument by a cable. The external computer determines “fitting” values, which are downloaded into and stored in the instrument. This method, however, requires the use of relatively expensive and complex programming devices or systems and extensively trained personnel, thereby being a relatively expensive process. Also, the cost and complexity of such systems means that such systems will be relatively uncommon, unlike, for example, a screwdriver, so that the user of the hearing instrument must travel to one of a limited number of facilities to have their instrument fitted.

A variation of the programming method involves the use of a remote control device, such as a magnet, infrared transmitter or analogous device, to interact with an appropriate sensing device in the instrument to “step through” or to directly communicate values for the circuits. Although such methods typically eliminate the need for cable connections and for complex external devices, such methods may be as complex and expensive as the programming method and typically lack the flexibility of the programming method. Such methods are convenient in some respects in that the user may often be provided with a personal, easily portable “programming device”, such as a magnet. It should be noted, however, that such methods are also generally more vulnerable to outside interference, such as stray magnetic fields.

Finally, certain instruments employ internal and automatic signal analysis circuits to analyze the incoming sounds and to automatically adjust the characteristics of the instrument accordingly. Such methods, however, are complex and expensive and offer only a limited range of adjustments or adjustment ranges.

### SUMMARY OF THE INVENTION

The present invention pertains to a method and device for adjusting, or “trimming”, the circuit characteristics of values of a hearing instrument. The trimmer device includes a set of external trimmer elements, such as resistors, which are connected into the hearing instrument internal circuitry by means of a cable. The values of the trimmer elements are periodically sampled by the instrument's circuitry when the trimmer device is connected to the instrument, and the values of the trimmer elements are stored in an internal memory to control the characteristics of the hearing instrument. When a satisfactory set of adjustment values are achieved, the trimmer device is disconnected from the hearing instrument until required for further adjustments and the last stored trimmer element values remain stored in the instrument to control the characteristics of the instrument. A fitting card identifying the user or the

instrument is associated with each hearing instrument and may be fitted to the trimmer device to record the trimmer element settings stored in the instrument.

### BRIEF DESCRIPTION OF THE DRAWINGS

The invention will now be described, by way of example, with reference to the accompanying drawings in which:

FIGS. 1 and 2 are diagrammatic representations of embodiments of a hearing instrument and external fitting device;

FIG. 3 illustrates aspects of a user interface to the external fitting device; and

FIG. 4 is a flow diagram illustrating the method of the present invention.

### DESCRIPTION OF THE PREFERRED EMBODIMENT(S)

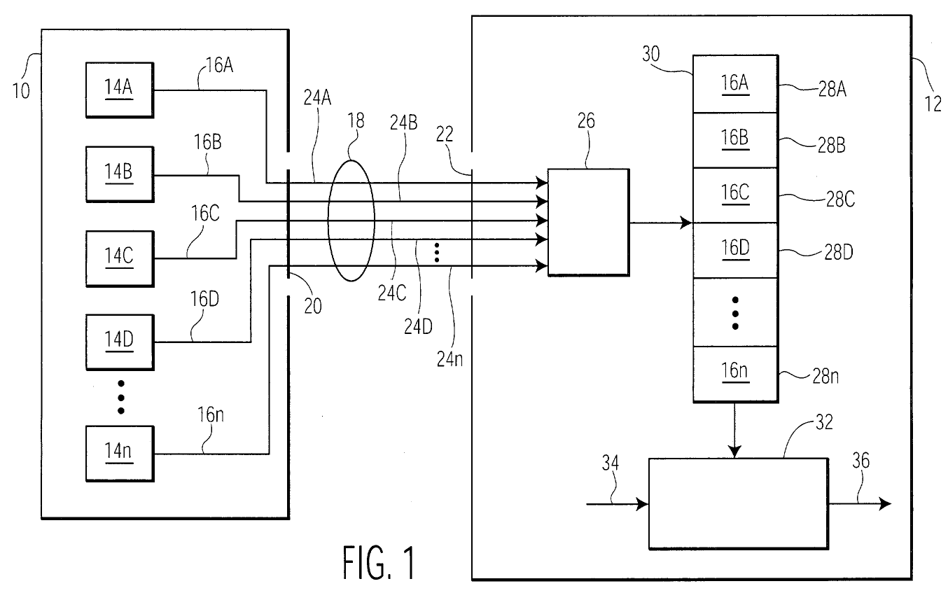

Referring to FIG. 1, therein appears a diagrammatic representation of an embodiment of the present invention for a method and apparatus for the “fitting” of a hearing instrument.

As shown therein, and according to the present invention, a Fitting Device 10 is external to and connectable to a hearing Instrument 12 and contains one or more FittingTrimmers 14 for generating one or more Fitting Values 16 representing one or more corresponding “fitting settings” for adjusting the characteristics of the Instrument 12 to an individual user of the Instrument 12. A given Fitting Device 10, however, is not necessarily limited to use with a single Instrument 12 but may be used with one or more Instruments 12 so long as the Instruments 12 have common or sufficiently similar trimming circuits and the same or sufficiently similar trimming adjustments. A given user may thereby be provided with their own, personal Fitting Device 10, which is feasible given the relatively low cost of Fitting Devices 10 compared to other methods, or a given Fitting Device 10 may be used with and for a plurality of users and Instruments 12.

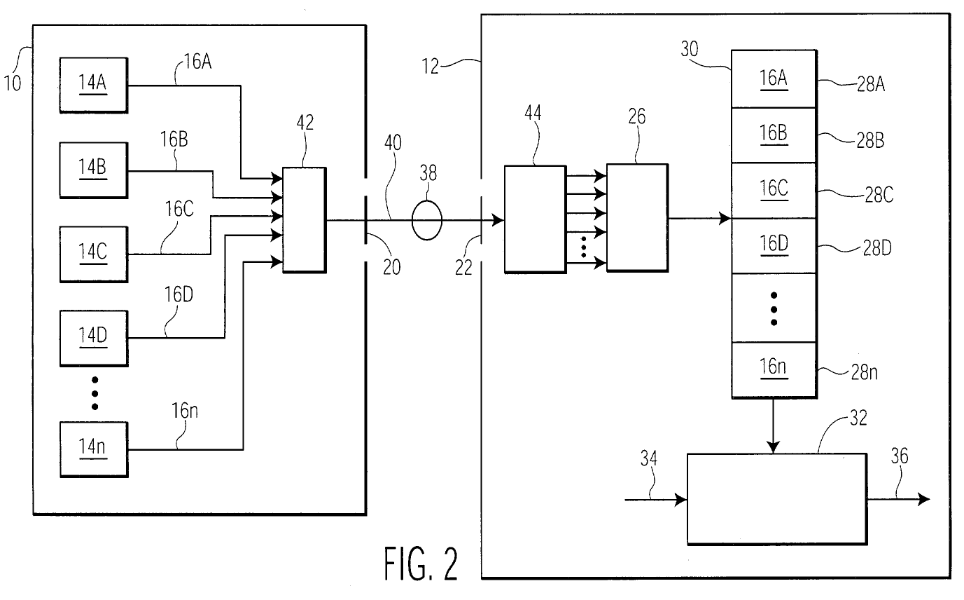

A given Fitting Device 10 as illustrated in FIGS. 1 and 2 will typically include a FittingTrimmer 14 for and corresponding to each fitting setting to be determined for the Instrument 12, so that a Fitting Device 10 may include FittingTrimmers 14A, 14B, . . . 14n for and corresponding to Fitting Values 16A, 16B, . . . , 16n. For example, and as illustrated in FIGS. 1, 2 and 3, an Instrument 12 may include four FittingTrimmers 14A, 14B, 14C and 14D providing four Fitting Values 16A, 16B, 16C and 16D, each corresponding to one of an Overall Gain setting, a Node Low (NL) setting, a Node High (NH) setting and an Automatic Gain Control (AGC) setting.

A FittingTrimmer 14 may be any element, component or circuit capable of generating a Fitting Value 16 representing a corresponding fitting setting of an Instrument 12. For example, in a typical embodiment of a Device 10, the FittingTrimmers 14 may be variable resistors or potentiometers, as illustrated in FIGS. 1 and 2. In other embodiments, however, one or more FittingTrimmers 14 may be other forms of variable resistance elements, such as one or more

analog resistor networks or user alterable semiconductor resistors or resistor adjustors, variable capacitors, variable inductors, or any other type of component, element or circuit capable of generating a Fitting Value 16, which may in turn be represented by an ac or dc voltage level, or the frequency, pulse width or amplitude of an analog or digital signal, and so on.

In the implementation of a Device 10 and Instrument 12 as illustrated in FIG. 1, the Device 10 may be connected into an Instrument 12 through a multiple conductor Cable 18 connected from an Output Port 20 of the Device 10 and to an Input Port 22 of the Instrument 12. A multiple conductor Cable 18 will typically include a Lead 24, indicated as Leads 24A . . . 24n, each of which will be connected from or to a corresponding FittingTrimmer 14 and which will carry a corresponding Fitting Value 16. As illustrated, Lead 24 is connected to the input of a Sample and Hold Circuit (S&H) 26, which samples and hold the value of each of the current Fitting Values 16 generated by the corresponding FittingTrimmers 14A. The Instrument 12 may include a S&H 26 for each individual Lead 24, or may have a single S&H 26 with a multiplexed input for connecting each Lead 24 in turn into the input of the S&H 26. The sampled and held Fitting Value 16 outputs of S&H 26 are then stored in corresponding Fitting Memory Locations 28 of a Fitting Memory 30, indicated as Fitting Memory Locations 28A, . . . 28n. The stored Fitting Values 16 are then provided from Fitting Memory 30 to control inputs of Sound Processor Circuitry 32 to control the relevant characteristics of Sound Processing Circuitry 32. As well known in the relevant arts, Sound Processor Circuitry 32 performs the desired operations on sound signals received through Input 34, which is typically some form of microphone, and provides the results as a sound output through Output 36, which is typically some form of transducer, wherein one or more of the operations and parameters of the operations performed on the received sound is controlled by the stored Fitting Values 16.

In this regard, it will be understood that the Fitting Memory Locations 28 and the elements and functions of Fitting Memory 30 may be implemented in circuitry that is functionally separate from Sound Processor Circuitry 32, or by circuits within Sound Processor Circuitry 32 and may be implemented in a variety of elements or forms of circuits, all of which are well known to those of ordinary skill in the arts. In a like manner, the functions and operations of S&H 24 may be implemented as separate circuitry or as circuitry within Sound Processor Circuitry 32, and so on.

An alternate implementation of a Device 10 and Instrument 12 is illustrated in FIG. 2 wherein the Device 10 and the Fitting Values 14 therefrom are connected to the Instrument 12 through a “single conductor” Cable 38 from Port 20 of the Device 10 to Port 22 of the Instrument 12. In this regard, it will be recognized that the term “single conductor” cable refers to a cable having a single signal Lead 40 and that the cable will typically also include a “ground” or “return” lead and may include a “shield”. Because a number of Fitting Values 16 must be transmitted over the single Lead 40, the Device 10 will include a Multiplexer (MUX) 42 or equivalent circuit function for sequentially connecting the outputs of FittingTrimmers 14 to Lead 40 of Cable 38 and thereby sequentially providing the Fitting Values 16 of each of the FittingTrimmers 14 to Port 22 of the Instrument 12. The Instrument 12 will in turn include a Demultiplexer (DEMUX) 44 function for sequentially providing the Fitting Values 16 to an input of S&H 26, which will in turn sample and hold and store Fitting Values 16 in Fitting Memory 30 as described above.

As will be well understood by those of ordinary skill in the arts, MUX 42 and DEMUX 44 may be implemented through any of a wide range of methods. For example, the MUX 42 function may be performed by a switched analog multiplexer, by tri-state gate circuits, a mechanical switch, and so on. The DEMUX 44 function may, in turn, be performed by gate circuits, a demultiplexer circuit, the timing of a sample and hold circuit periodically sampling and holding the fitting value presently appearing on the Lead 40 at a given time, and so on. As such, it will be recognized by those of skill in the arts that the circuits represented in the figures are representative of functions or operations rather than of specific circuits and that the functions and operations may be equally performed or provided by any of a wide range of circuits, all of which are well known to those of ordinary skill in the relevant arts.

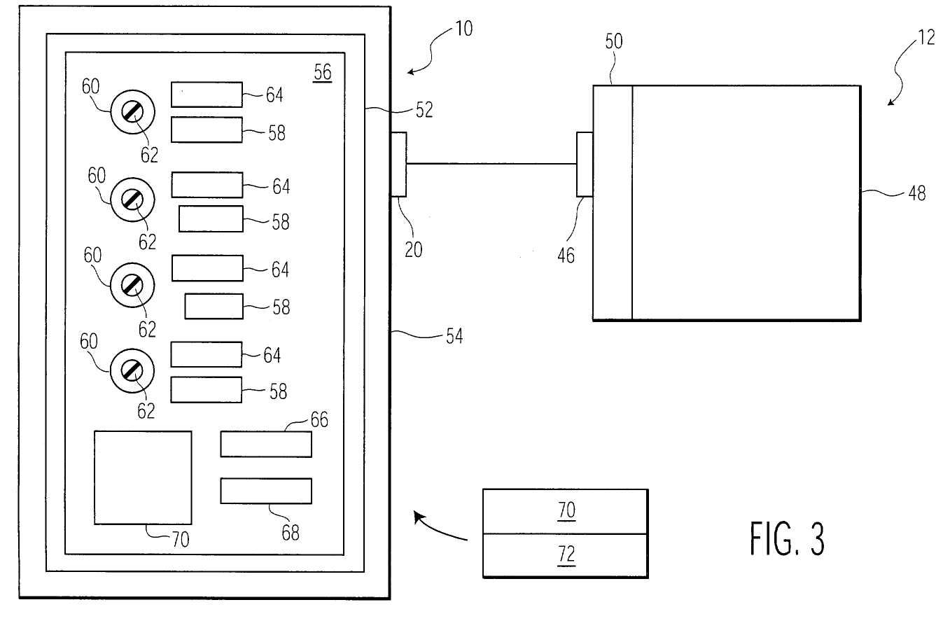

Referring now to FIG. 3, therein is illustrated further aspects of implementations of the present invention. For example, as described above with reference to FIGS. 1 and 2 and as illustrated further in FIG. 3, Fitting Device 10 will be provided with a multiconductor Cable 18 or a single conductor Cable 40 for connecting the Fitting Device 10 to an Instrument 12 wherein the cable may be, for example, a flex cable or any other suitable form of cable. In this regard, it should be noted that a cable connection is typically used to configure the Instrument 12 during manufacture of the Instrument 12 and the cable interconnecting the Device 10 with the Instrument 12 cable may be of the same type of cable or a compatible type of table. As described, the cable will connect into Instrument 12 through a Port 22, which may be implemented through an appropriate Connector 46 which may be, for example, a basic CS44 or CS 45 connector or flex connector and may be the same connecter used for configuration of the Instrument 12 during manufacture. In this regard, it should be noted that an Instrument 12 includes a Housing 48 and will typically include a Faceplate 50 providing access to the Instrument 12 electronics and that Housing 48 and Faceplate 50 will together form an enclosure for the electronics of the Instrument 12 and will form the outer contour of the Instrument 12. Connector 46 may be mounted to the Instrument 12 through Housing 48 or, for example and as illustrated in FIG. 3, through Faceplate 50 wherein Faceplate 50 may be, for example, a traditional form of faceplate or a semi-modular faceplate.

As described herein above, a Fitting Device 10 will include one or more Trimmer Adjustors 14 for determining and controlling the fitting adjustments of an Instrument 12 and a Fitting Device 10 and Instrument 12 may employ any of a variety of elements to generate and provide any of a wide range of Fitting Value 16 signals representing the fitting settings for an Instrument 12. As suggested, Fitting Values 16 may be generated as or represented by various forms of analog or digital signals, signal frequencies or signal amplitudes, the values of variable resistances, the values of variable capacitors, and so on.

According to the present invention, an Instrument 12 will be provided with an associated and corresponding Fitting Card 52 to store and display at least information identifying the specific Instrument 12 and the Fitting Values 16 currently stored therein and determining the current fitting characteristics of the Instrument 12. As illustrated in FIG. 3, a Fitting Card 52 is mountable or fittable to a Face 54 of a corresponding Fitting Device 10 and will include at least a Data Area 56 for recording and displaying at least Fitting Data 58 including information identifying the specific Instrument 12 and the Fitting Values 16 currently stored in the Instrument 12. Fitting Data 58 may also include other information pertinent to the Instrument 12, its fitting settings and the user of the Instrument 12.

As illustrated in FIG. 3, and depending upon the type of FittingTrimmers 14 used and the type of adjustments provided to adjust the FittingTrimmers 14, the Data Area 56 may include Adjustment Ports 60 providing access to the Adjustment Controls 62 of FittingTrimmers 14. Data Area 56 in the region of Adjustment Ports 60 may be used, for example, to identify the individual FittingTrimmers 14 and the corresponding fitting settings, such as an Overall Gain setting, a Node Low (NL) setting, a Node High (NH) setting and an Automatic Gain Control (AGC) setting, and the current Fitting Values 16 for each FittingTrimmer 14. As illustrated in FIG. 3, and for example, the Adjustment Controls 62 of FittingTrimmers 14 may have screwdriver type adjustments, such as a screwdriver slot in the head of a shaft or rod by which the value of the adjustment may be changed by turning the shaft or rod, or, for example, “slider” type controls or “thumbwheel” controls. In certain embodiments, therefore, the current Fitting Values 16 stored in the Instrument 12 may be indicated by markings in Data Area 56 adjacent Adjustment Ports 60 indicating the physical positions of the corresponding Adjustment Controls 62.

In general, therefore, the Data Area 56 of a Fitting Card 52 will include one or more Labels 64 for and corresponding to each FittingTrimmer 14 and indicating the function of the associated FittingTrimmer 14. A Fitting Card 52 will also include one or both of a User Identification 66 of the specific user of the Instrument 12 or an Instrument Identification 68 of the corresponding Instrument 12, and may include a Notes Area 70 for recording, for example,

notes or records of the settings of FittingTrimmers 14, or ideas, suggestions or directions for the setting of FittingTrimmers 14. The current settings of FittingTrimmers 14 will also typically be noted on the Fitting Card 52, for example, by recording the Trimming Values 16 in Data Area 56 or by equivalent or corresponding markings in Data Area 56 or by markings Data Area 56 or in region of Adjustment Ports 60 indicating the positions of the associated FittingTrimmers 14. It will be recognized and understood, however, that Fittings Data 58 may be stored on or in a Fittings Card 52 in any of a variety of forms, such as by one or more bar codes, sticky labels, solid state memories of various sorts, such as semiconductor memories, magnetic strips or labels, any of which may be attached to or embedded in a Fitting Card 52, or the Fitting Card 52 itself may be a memory or data storage card of any of a variety of forms. In certain implementations, therefore, the Device 10 may include or be associated with a Reader 70 with an associated Display 72 that is capable of either or both of reading or writing bar codes, memory cards, solid state memories, magnetic strips, and so on, and the Fitting Card 52 may be placed in the Reader 70 rather than attached to the Face 54 of the Device 10.

In use, therefore, and when an Instrument 12 is to be “fitted” for a given user, the Fitting Card 52 of that user or Instrument 12 is affixed appropriately to the Face 54 of the Fitting Device 10, or placed in the associated Reader 70, and, in the presently preferred embodiment, the FittingTrimmers 14 are set to the values or positions indicated by the Fitting Card 52 as the current, or last set, of Fitting Values 16. The Fitting Device 10 is then connected to the Instrument 12 through the Cable 18 or Cable 40, depending upon the specific implementation, wherein the Instrument 12 may remain in or be replaced in the user's ear while or after the connection is made. The circuitry of the Instrument 12 will detect the presence of the connection to the Fitting Device 10 and will begin sampling and holding the values of the FittingTrimmers 14, which may then be adjusted as necessary and desired. The circuitry of the Instrument 12 will continue to sample, hold and store the Fitting Values 16 of the FittingTrimmers 14 so long as Fitting Device 10 is connected to the Instrument 12 or until a “finish” command is entered, thereby determining and storing the Fitting Values 16 set through FittingTrimmers 14. When the Device 10 is disconnected from the Instrument 12, the last sampled Fitting Values 16 will remain stored in the Instrument 12 and will control the corresponding operations and parameters of the Instrument 12. The new fitting values may then be recorded on or in the Fitting Card 52 for subsequent use for that user as necessary, such as at a next testing or adjustment of the Instrument 12.

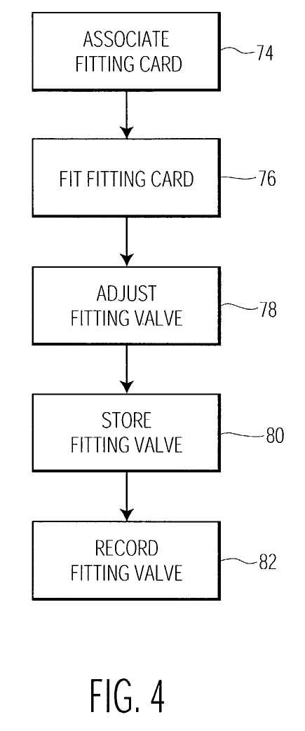

In summary, therefore, and as illustrated in FIG. 4, the method for fitting a hearing instrument of the present invention may include the steps of:

Step 74: associating a Fitting Card 52 with a hearing Instrument 12 wherein a Fitting Card 52 will include at least one of a User Identification 66 of the specific user of the Instrument 12 or an Instrument Identification 68 of the corresponding Instrument 12 and will include a Data Area 56 for recording a setting of at least one corresponding Fitting Value 16 of the Instrument 12;

Step 76: Fitting the Fitting Card 52 to a Fitting Device 10 operable with the Instrument 12;

Step 78: Adjusting a setting of at least one Fitting Trimmer 14 of the Fitting Device 10 corresponding to at least one Fitting Value 16 of the Instrument 12 to be adjusted;

Step 80: Storing the at least one Fitting Value 16 generated by the at least one Fitting Trimmer 14 in the Instrument 12 to control a corresponding characteristic of the Instrument 12; and

Step 82: Recording the setting of the at least Fitting Value 16 in a Data Area 56 of the Fitting Card 52.

Since certain changes may be made in the above described invention without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An external fitting device for use in adjusting operational characteristics of a hearing instrument, comprising:
a plurality of user adjustable fitting trimmers for adjusting a corresponding plurality of operational characteristics of a hearing instrument and being separate from the hearing instrument; and
an output port for use in coupling the plurality of fitting trimmers to the hearing instrument.

2. The external fitting device according to claim 1, wherein the output port couples the plurality of fitting trimmers to the hearing instrument by a cable.

3. The external fitting device according to claim 1, including a multiplexing circuit for providing a currently selected fitting value of the plurality of fitting trimmers to the output port.

4. The external fitting device according to claim 1, wherein the plurality of fitting trimmers comprise at least one of:
rotating adjustment potentiometers;
sliding adjustment potentiometers;
variable resistors;
potentiometers;
variable resistance elements;
analog resistor networks;
user alterable semiconductor resistors or resistor adjustors;
variable capacitors;
variable inductors; and
signal generators capable of generating at least one of an ac, de, analog and digital signal having at least one of a selectable voltage level, frequency, pulse width and amplitude.

5. The external fitting device of claim 1, the hearing instrument comprising:
a processor housing;
a first processor for receiving and processing sound signals to provide processed sound to a user, the first processor operational characteristics being responsive to fitting values received from an interface processor; and
an interface processor for processing fitting values received from the external fitting device and providing processed fitting values to the first processor and for storing selected fitting values upon completion of trimming, the fitting values being derived from a plurality of user adjustable fitting trimmers separate from the hearing instrument.

6. The external fitting device of claim 5, wherein the interface processor processes received fitting values with a sample and hold function.

7. A hearing instrument for insertion in an ear of a user comprising:
a processor housing;
a first processor for receiving and processing sound signals to provide processed sound to a user, the first processor operational characteristics being responsive to fitting values received from an interface processor; and
an interface processor for processing fitting values received from an external fitting device and providing processed fitting values to the first processor and for storing selected fitting values upon completion of trimming, the fitting values being derived from a plurality of user adjustable fitting trimmers separate from the hearing instrument.

8. The hearing instrument according to claim 6, wherein the interface processor includes a de-multiplexing circuit for de-multiplexing fitting values received from the external fitting device to provide a currently selected fitting value from one of the plurality of fitting trimmers to the interface processor.

9. The external fitting device according to claim 6, wherein the interface processor processes received fitting values with a sample and hold function.

10. The hearing instrument of claim 6, the external fitting device comprising:
a plurality of user adjustable fitting trimmers for adjusting a corresponding plurality of operational characteristics of the hearing instrument; and
an output port for use in coupling the plurality of fitting trimmers to the hearing instrument.

11. The external fitting device according to claim 9, wherein the output port couples the plurality of fitting trimmers to the hearing instrument by a cable.

12. The external fitting device according to claim 9, including a multiplexing circuit for providing a currently selected fitting value of the plurality of fitting trimmers to the output port.

13. A method for trimming a plurality of operational characteristics of a hearing instrument, comprising the steps of:
connecting an external fitting device to a port of the hearing instrument,
the external fitting device including
a plurality of user adjustable fitting trimmers for adjusting corresponding ones of the plurality of operational characteristics of the hearing instrument and providing corresponding fitting values; and
an output port for use in coupling the plurality of fitting trimmers to the port of the hearing instrument,
providing one or more currently selected fitting values of the plurality of fitting trimmers of the external fitting device to the output port of the fitting device and to the port of the hearing instrument,
processing the fitting values received from an external fitting device and storing selected fitting values upon completion of trimming,
providing the stored fitting values to a sound processor for receiving and processing sound signals to provide processed sound to a user.

14. The external fitting device of claim 1, further comprising:
a fitting card associated with a hearing instrument and fittable to a face of a fitting device and including
at least one adjustment port corresponding to at least one corresponding Fitting adjustor of a fitting device,
an identification of at least one of the associated hearing instrument and a user of the associated hearing instrument, and
a record of a setting of at least the at least one corresponding fitting adjustor of a fitting trimmer.

15. The hearing instrument of claim 7, further comprising:
a fitting card associated with the hearing instrument and fittable to a face of a fitting device and including
at least one adjustment port corresponding to at least one corresponding fitting adjustor of a fitting trimmer,
an identification of at least one of the hearing instrument and a user of the hearing instrument, and
a record of a setting of at least the at least one corresponding fitting adjustor of a fitting trimmer.

16. The method for trimming a plurality of operational characteristics of a hearing instrument of claim 13, further comprising the steps of:
associating a fitting card with a hearing instrument, a fitting card including
at least one adjustment port corresponding to at least one corresponding fitting adjustor of a fitting trimmer of a fitting device,
an identification of at least one of the associated hearing instrument and a user of the associated hearing instrument, and
a data area for recording a setting of at least the at least one corresponding fitting adjustor of a fitting device,
fitting the fitting card to a fitting device operable with the hearing instrument,
adjusting a setting of the at least one fitting adjustor of a fitting trimmer, and
recording the setting of the at least one fitting adjustor in the record area.
